(19) United States
(12) Patent Application Publication
(10) Pub. No.: US 2010/0200570 A1
(43) Pub. Date: Aug. 12, 2010

(54) SYSTEM AND METHOD FOR REDUCING CROSSTALK BETWEEN WORKCOILS IN INDUCTION HEATING APPLICATIONS

(75) Inventors: Salvatore Chirico, Port Moody (CA); Nicholas Dohmeier, North Vancouver (CA); Keith McCormick, Burnaby (CA)

Correspondence Address: HONEYWELL/MUNCK;Patent Services, 101 Columbia Road, P.O. Box 2245, Morristown, NJ, 07962-2245, US

(73) Assignee: Honeywell International Inc., Morristown, NJ (US)

(21) Appl. No.: 12/368,244

(22) Filed: Feb. 9, 2009

(51) Int. Cl. H05B 6/14

(52) U.S. Cl. 219/619

(57) ABSTRACT

A system includes a roll formed from a conductive material, where the roll is configured to rotate about an axis and has a direction of rotation. The system also includes multiple induction heating workcoils each configured to induce one or more magnetic fluxes within the roll to generate one or more electrical currents within the roll. Each induction heating workcoil can be oriented so that a mean magnetic flux induced by the workcoil is oblique to the roll's direction of rotation. Each of the induction heating workcoils could represent an unbalanced induction heating workcoil, or each of the induction heating workcoils could include a core having a shape that is not substantially dependent on the roll's diameter.

### CROSS-REFERENCE TO RELATED APPLICATIONS

This disclosure is related to the following U.S. patent applications, which are incorporated by reference:

Ser. No. 12/103,173 entitled “SYSTEM, APPARATUS, AND METHOD FOR INDUCTION HEATING USING FLUX-BALANCED INDUCTION HEATING WORKCOIL” filed on Apr. 15, 2008;

Ser. No. 12/103,195 entitled “SYSTEM AND METHOD FOR REDUCING CURRENT EXITING A ROLL THROUGH ITS BEARINGS” filed on Apr. 15, 2008; and

Ser. No. 12/103,239 entitled “SYSTEM AND METHOD FOR REDUCING CURRENT EXITING A ROLL THROUGH ITS BEARINGS USING BALANCED MAGNETIC FLUX VECTORS IN INDUCTION HEATING APPLICATIONS” filed on Apr. 15, 2008.

### TECHNICAL FIELD

This disclosure relates generally to paper production systems and other systems using rolls. More specifically, this disclosure relates to a system and method for reducing crosstalk between workcoils in induction heating applications.

### BACKGROUND

Paper production systems and other types of continuous web systems often include a number of large rotating rolls. For example, sets of counter-rotating rolls can be used in a paper production system to compress a paper sheet being formed. The amount of compression provided by the counter-rotating rolls is often controlled through the use of induction heating workcoils. The induction heating workcoils create currents in a roll, which heats the surface of the roll. The heat or lack thereof causes the roll to expand or contract, which controls the amount of compression applied to the paper sheet being formed.

In some prior production systems, induction heating workcoils were aligned with their associated roll's direction of rotation. In other words, the workcoils were oriented so that magnetic fluxes produced by the workcoils in the roll were generally parallel to the roll's direction of rotation.

In other prior production systems, certain types of induction heating workcoils were rotated slightly so as to be somewhat oblique to their associated roll's direction of rotation. For example, balanced induction heating workcoils that are dependent on roll diameter have been rotated between 11° and 13° in order to average the energy transfer profile across the roll, which can produce more even heating across the roll. However, in these prior systems, further rotation of the induction heating workcoils would have a negative impact on the energy transfer profile, making it more difficult to control the energy transfer profile across the roll. This is not desirable since, for instance, it can cause visible streaks in a web of paper being manufactured.

### SUMMARY

This disclosure provides a system and method for reducing crosstalk between workcoils in induction heating applications.

In a first embodiment, a system includes a roll formed from a conductive material, where the roll is configured to rotate about an axis and has a direction of rotation. The system also includes multiple unbalanced induction heating workcoils each configured to induce one or more magnetic fluxes within the roll to generate one or more electrical currents within the roll. Each of the unbalanced induction heating workcoils is oriented so that a mean magnetic flux induced by the workcoil is oblique to the roll's direction of rotation.

In a second embodiment, a system includes a roll formed from a conductive material, where the roll is configured to rotate about an axis and has a diameter and a direction of rotation. The system also includes multiple induction heating workcoils each configured to induce one or more magnetic fluxes within the roll to generate one or more electrical currents within the roll. Each of the induction heating workcoils is oriented so that a mean magnetic flux induced by the workcoil is oblique to the roll's direction of rotation. Also, each of the induction heating workcoils includes a core having a shape that is not substantially dependent on the roll's diameter.

In a third embodiment, a method includes placing multiple induction heating workcoils in proximity with a roll and generating multiple electrical currents within the roll using the induction heating workcoils. Each induction heating workcoil is oriented such that a mean of one or more magnetic fluxes induced within the roll by the workcoil is oblique to the roll's direction of rotation so as to reduce inductive coupling between the induction heating workcoils.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example paper production system according to this disclosure;

FIG. 2 illustrates an example orientation of induction heating workcoils with respect to a roll according to this disclosure;

FIGS. 3A and 3B illustrate an example induction heating workcoil according to this disclosure;

FIGS. 4A through 4C illustrate other example induction heating workcoils according to this disclosure;

FIG. 5 illustrates example reductions in crosstalk due to rotation of induction heating workcoils according to this disclosure;

FIG. 6 illustrates an example configuration of induction heating workcoils with respect to a roll according to this disclosure; and

FIG. 7 illustrates an example method for reducing crosstalk between workcoils in induction heating applications according to this disclosure.

### DETAILED DESCRIPTION

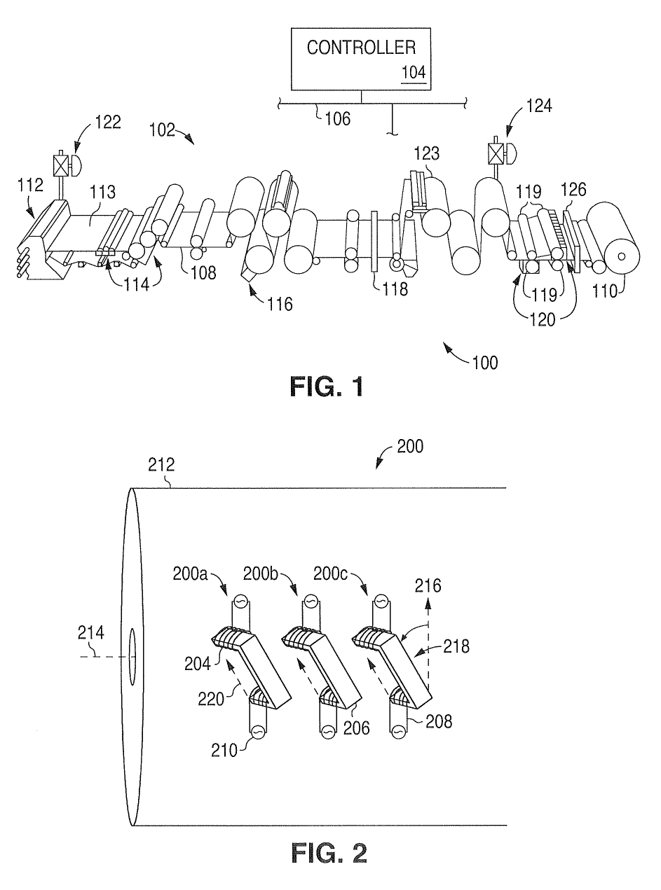

FIGS. 1 through 7, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example paper production system 100 according to this disclosure. The embodiment of the paper production system 100 shown in FIG. 1 is for illustration only. Other embodiments of the paper production system 100 may be used without departing from the scope of this disclosure.

As shown in FIG. 1, the paper production system 100 includes a paper machine 102, a controller 104, and a network 106. The paper machine 102 includes various components used to produce a paper product. In this example, the various components may be used to produce a continuous paper web or sheet 108 collected at a reel 110. The controller 104 monitors and controls the operation of the system 100, which may help to maintain or increase the quality of the paper sheet 108 produced by the paper machine 102.

In this example, the paper machine 102 includes a headbox 112, which distributes a pulp suspension uniformly across the machine onto a continuous moving wire screen or mesh 113. The pulp suspension entering the headbox 112 may contain, for example, 0.2-3% wood fibers, fillers, and/or other materials, with the remainder of the suspension being water. The headbox 112 may include an array of dilution actuators, which distributes dilution water or a suspension of different composition into the pulp suspension across the sheet. The dilution water may be used to help ensure that the resulting paper sheet 108 has a more uniform basis weight or more uniform composition across the sheet 108. The headbox 112 may also include an array of slice lip actuators, which controls a slice opening across the machine from which the pulp suspension exits the headbox 112 onto the moving wire screen or mesh 113. The array of slice lip actuators may also be used to control the basis weight of the paper or the distribution of fiber orientation angles of the paper across the sheet 108.

An array of drainage elements 114, such as vacuum boxes, removes as much water as possible. An array of steam actuators 116 produces hot steam that penetrates the paper sheet 108 and releases the latent heat of the steam into the paper sheet 108, thereby increasing the temperature of the paper sheet 108 in sections across the sheet. The increase in temperature may allow for easier removal of additional water from the paper sheet 108. An array of rewet shower actuators 118 adds small droplets of water (which may be air atomized) onto one or both surfaces of the paper sheet 108. The array of rewet shower actuators 118 may be used to control the moisture profile of the paper sheet 108, reduce or prevent over-drying of the paper sheet 108, correct any dry streaks in the paper sheet 108, or enhance the effect of subsequent surface treatments (such as calendering).

The paper sheet 108 is then often passed through a calender having several nips of counter-rotating rolls 119. Arrays of induction heating workcoils 120 heat the surfaces of various ones of these rolls 119. As each roll surface locally heats up, the roll diameter is locally expanded and hence increases nip pressure, which in turn locally compresses the paper sheet 108 and transfers heat energy to it. The arrays of induction heating workcoils 120 may therefore be used to control the caliper (thickness) profile of the paper sheet 108. The nips of a calender may also be equipped with other actuator arrays, such as arrays of air showers or steam showers, which may be used to control the gloss profile or smoothness profile of the paper sheet.

Two additional actuators 122-124 are shown in FIG. 1. A thick stock flow actuator 122 controls the consistency of the incoming stock received at the headbox 112. A steam flow actuator 124 controls the amount of heat transferred to the paper sheet 108 from drying cylinders 123. The actuators 122-124 could, for example, represent valves controlling the flow of stock and steam, respectively. These actuators may be used for controlling the dry weight and moisture of the paper sheet 108. Additional components could be used to further process the paper sheet 108, such as a supercalender (for improving the paper sheet's thickness, smoothness, and gloss) or one or more coating stations (each applying a layer of coatant to a surface of the paper to improve the smoothness and printability of the paper sheet). Similarly, additional flow actuators may be used to control the proportions of different types of pulp and filler material in the thick stock and to control the amounts of various additives (such as retention aid or dyes) that are mixed into the stock.

This represents a brief description of one type of paper machine 102 that may be used to produce a paper product. Additional details regarding this type of paper machine 102 are well-known in the art and are not needed for an understanding of this disclosure. Also, this represents one specific type of paper machine 102 that may be used in the system 100. Other machines or devices could be used that include any other or additional components for producing a paper product. In addition, this disclosure is not limited to use with systems for producing paper sheets and could be used with systems that process the paper sheets or with systems that produce or process other products or materials in continuous webs (such as plastic sheets or thin metal films like aluminum foils).

In order to control the paper-making process, one or more properties of the paper sheet 108 may be continuously or repeatedly measured. The sheet properties can be measured at one or various stages in the manufacturing process. This information may then be used to adjust the paper machine 102, such as by adjusting various actuators within the paper machine 102. This may help to compensate for any variations of the sheet properties from desired targets, which may help to ensure the quality of the sheet 108.

As shown in FIG. 1, the paper machine 102 includes a scanner 126, which may include one or more sensors. The scanner 126 is capable of scanning the paper sheet 108 and measuring one or more characteristics of the paper sheet 108. For example, the scanner 126 could include sensors for measuring the weight, moisture, caliper (thickness), gloss, color, smoothness, or any other or additional characteristics of the paper sheet 108. The scanner 126 includes any suitable structure or structures for measuring or detecting one or more characteristics of the paper sheet 108, such as sets or arrays of sensors.

The controller 104 receives measurement data from the scanner 126 and uses the data to control the system 100. For example, the controller 104 may use the measurement data to adjust the various actuators in the paper machine 102 so that the paper sheet 108 has properties at or near desired properties. The controller 104 includes any hardware, software, firmware, or combination thereof for controlling the operation of at least part of the system 100. Also, while one controller is shown here, multiple controllers could be used to control the paper machine 102.

The network 106 is coupled to the controller 104 and various components of the system 100 (such as actuators and scanners). The network 106 facilitates communication between components of system 100. The network 106 represents any suitable network or combination of networks facilitating communication between components in the system 100. The network 106 could, for example, represent an Ethernet network, an electrical signal network (such as a HART or FOUNDATION FIELDBUS network), a pneumatic control signal network, or any other or additional network(s).

In one aspect of operation, the induction heating workcoils 120 operate by generating magnetic fluxes on the surface of one or more rolls 119, creating electrical currents in the surface of those rolls 119. In some conventional systems, undesirable inductive coupling can occur between neighboring induction heating workcoils. This coupling or “crosstalk” can transfer energy from one workcoil to another workcoil through a shared magnetic field, which can transfer power from one workcoil (where it is wanted) to another workcoil (where it is not wanted). This can reduce stable operation of the workcoils and their associated power modules, resulting in poorer performance, lower efficiency, control difficulties, and damage. This crosstalk also often requires that workcoils and their power modules have the capacity to handle the increased energy that may be transferred during crosstalk, which increases the cost of the workcoils and their power modules. While the workcoils could be separated by larger distances to reduce the crosstalk, this would also reduce the density of the electromagnetic fields produced using the workcoils (and therefore also interfere with the control of the heating across a roll since it alters the currents created in the roll).

In accordance with this disclosure, the induction heating workcoils 120 are oriented in a way that reduces the amount of crosstalk between neighboring workcoils 120. In particular, the induction heating workcoils 120 are rotated so that their induced flux vectors are oblique (neither parallel nor perpendicular) to their roll or rolls' direction of rotation. The induced flux vectors produced by the induction heating workcoils 120 may still be generally parallel to one another, but the flux vectors are slanted towards the sides of the roll(s) 119. For example, a workcoil 120 could be rotated approximately 35°, yielding a flux vector on its roll's surface that is also rotated approximately 35° with respect to the roll's rotation direction. This can significantly reduce or minimize crosstalk between the workcoils 120. The specific angle or range of angles that the workcoils 120 are rotated may vary depending on the geometry or construction of the induction heating workcoils 120. The angle could be between 10 and 89° depending on the workcoils 120.

in this way, crosstalk between workcoils 120 can be reduced or minimized, helping to improve the performance and reduce the cost of the workcoils 120. Moreover, the workcoils 120 can be used in this manner without requiring further separation of the workcoils 120, meaning the workcoils 120 can be used without compromising control of the thermal profile across a roll 119 to any significant degree.

Although FIG. 1 illustrates one example of a paper production system 100, various changes may be made to FIG. 1. For example, other systems could be used to produce paper sheets or other products. Also, while shown as including a single paper machine 102 with various components and a single controller 104, the production system 100 could include any number of paper machines or other production machinery having any suitable structure, and the system 100 could include any number of controllers. In addition, FIG. 1 illustrates one operational environment in which induction heating workcoils 120 or other workcoils can be oriented to reduce or minimize crosstalk. This functionality could be used in any other suitable system.

FIG. 2 illustrates an example orientation 200 of induction heating workcoils with respect to a roll according to this disclosure. As shown in FIG. 2, three induction heating workcoils 202a-202c are positioned adjacent to each other in a row. Each of the induction heating workcoils 202a-202c includes at least two separately wound coils 204 and at least one core 206. Each coil 204 generally represents any suitable conductive material(s) wound in a coil or otherwise wrapped around at least a portion of a core 206. Each coil 204 could, for example, represent Litz wire or other conductive wire wrapped around a core 206. Each core 206 generally represents a structure that can direct, focus, or concentrate a magnetic field created by current flowing through at least one coil 204. Each core 206 could, for example, represent ferrite. Terminal wires 208 couple each coil 204 to a power source 210. A combination of one or more workcoils and one or more power sources forms an induction heating actuator. Each power source 210 generally represents a source of electrical energy flowing through one or more of the coils 204. Each power source 210 could, for example, represent an alternating current (AC) source that operates at a specified frequency (such as 16 kHz or other frequency). The AC signals flow through the coils 204 and produce magnetic fluxes in a roll 212, which rotates about an axis 214. The magnetic fluxes in the roll 212 produce currents in the surface of the roll 212, heating the surface of the roll 212. The production of the currents can be adjusted to control the amount of heating of the roll's surface, which also controls the amount of compression applied by the roll 212 to a paper sheet or other product.

As shown in this example, the induction heating workcoils 202a-202c are oblique or slanted with respect to the direction of rotation 216 of the roll 212. This creates an angle 218 between the direction of rotation 216 and the direction of magnetic flux vectors 220 created on the roll surface by each workcoil. The direction of each magnetic flux vector 220 is therefore also oblique or slanted with respect to the direction of rotation 216. The rotation of the workcoils 202a-202c (or at least the rotation of the magnetic flux vectors 220) significantly reduces or even minimizes crosstalk between the induction heating workcoils 202a-202c. For example, depending on the design of the workcoils 202a-202c, a rotation angle 218 of at least 35° could reduce crosstalk between the workcoils 202a-202c by up to 75% or even more. Other designs could have different rotation angles 218, such as angles greater than 0° and less than 90°.

This rotation helps to reduce crosstalk between the workcoils 202a-202c while, at the same time, helps to retain a closer proximity of the workcoils 202a-202c to one another. In other words, the workcoils 202a-202c can be placed relatively close together in order to help retain control over the thermal profile of the roll 212, while still allowing for a drastic reduction in crosstalk. The reduction in crosstalk is at least partially due to the outer corners of the workcoils' magnetic poles being closer to the roll 212, which reduces the air gap between the magnetic poles and the load (the roll) and thus reduces crosstalk.

In this embodiment, each of the induction heating workcoils 202a-202c represents an “unbalanced” workcoil, meaning the workcoil produces magnetic fluxes 220 that have an appreciably non-null sum spatial vector. The sum spatial vector is said to represent the “mean magnetic flux” produced by that workcoil. This is in contrast to a “balanced” workcoil, which would produce magnetic fluxes 220 that have an appreciably null sum spatial vector. Also, the cores 206 of the workcoils 202a-202c may or may not be substantially independent of the roll's diameter.

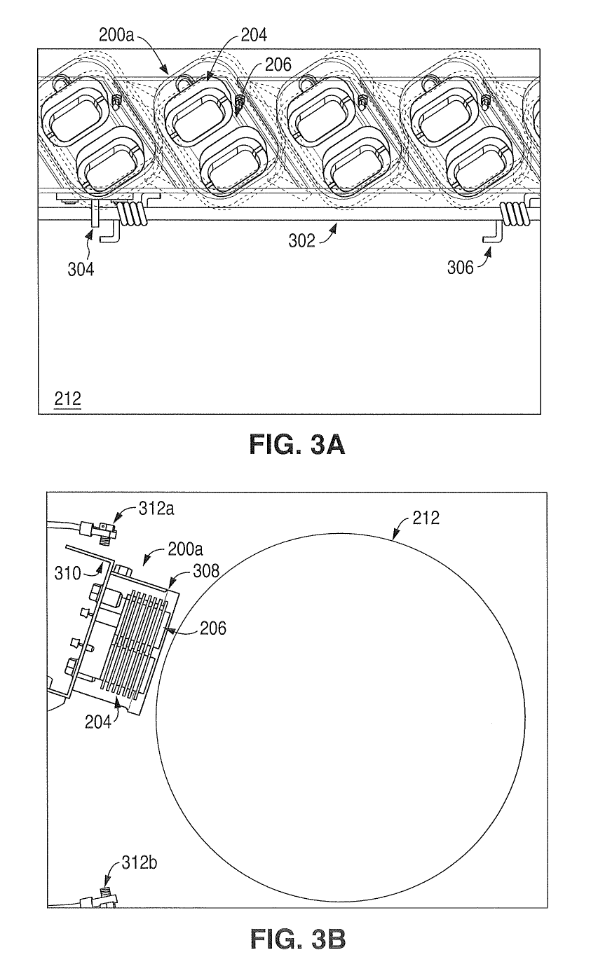

Note that any suitable type(s) of workcoils could be used here. In the example shown in FIG. 2, the induction heating workcoils 202a-202c have U-shaped or C-shaped cores 206, and a coil 204 is placed around each outer leg of the cores 206. FIGS. 3A and 3B illustrate an example induction heating workcoil according to this disclosure. In particular, FIGS. 3A and 3B illustrate the workcoils of FIG. 2 mounted or positioned near the roll 212. As shown in FIG. 3A, the workcoils include the coils 204 and the U-shaped or C-shaped cores 206. The workcoils may form part of a larger structure (such as a collection of workcoils packaged as a single unit) that is mounted on a bar 302 by various connectors 304. In this example, the connectors 304 allow for rotatable movement of the unit containing the workcoils around the bar 302. Springs 306 can be used to bias the unit containing the workcoils in a particular position, such as in an operational position where the workcoils are near the roll 212.

In FIG. 3B, one of the workcoils 202a is shown. In this example, the workcoil 202a includes the coils 204 and the core 206, along with a protective enclosure 308. The protective enclosure 308 protects and reinforces the core and coils of the workcoil 202a. The protective enclosure 308 could be formed from any suitable material(s), such as an epoxy potting or encapsulation, a varnish coating, or a sealed container. Also, the protective enclosure 308 could include filler powders or other material(s) that can increase conductivity of thermal energy away from the core and coils and towards a heatsink.

The workcoil 202a also includes a connector 310 on which the core 206 is mounted. The connector 310 includes projections that can be coupled to electrical cables 312a-312b, which are themselves coupled to one or more power sources 210. In this way, the workcoil 202a can be easily coupled to one or more power sources 210 for operation.

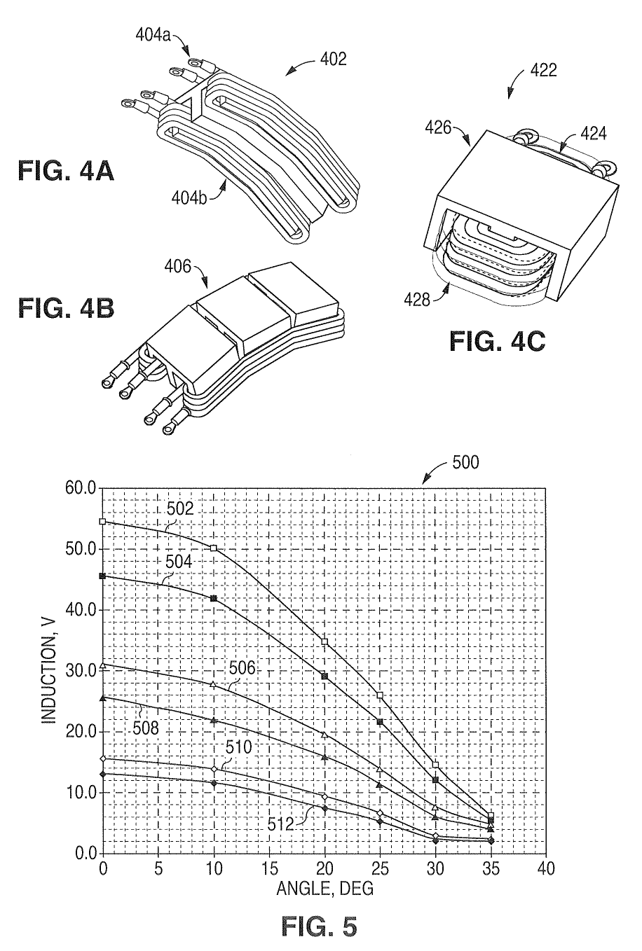

While the induction heating workcoils 202a-202c are shown here as having generally U-shaped or C-shaped cores with coils around the outer legs of the cores, various other types of induction heating workcoils could be used. FIGS. 4A through 4C illustrate other example induction heating workcoils according to this disclosure. In FIGS. 4A and 4B, an induction heating workcoil 402 includes multiple E-shaped cores 406 that are connected to form a larger arched or angled core. The workcoil 402 also includes coils 404a-404b that are wound lengthwise around each of the outer legs of the cores 406. The larger arched core formed by the cores 406 may or may not match, to a significant degree, the curvature of the roll with which the workcoil 402 is used.

In FIG. 4C, a workcoil 422 includes a coil 424 and a single E-shaped core 426. The coil 424 is wound around the inner leg of the E-shaped core 426. The workcoil 422 also includes a second coil 428 wound around the first coil 424. The second coil 428 in this example represents tubing or other hollow structure through which water or other fluid or material may pass. This allows thermal energy to be moved away from the coil 424 and/or the core 426. In this way, a cooling material can travel around the coil 424 and possibly on the open face of the workcoil 422 to help cool the workcoil 422 during operation. The second coil 428 could be formed from any suitable material(s), such as a non-ferromagnetic, non-metallic material like polytetrafluoroethylene (PTFE).

These represent merely several examples of the types of induction heating workcoils that can be used with a roll and oriented obliquely to the roll's direction of rotation. Note that any other or additional types of induction heating workcoils could be used. Also note that any suitable induction heating workcoil could have any suitable feature(s), including an arched core and/or a cooling mechanism (although other or additional features could also be used).

Although FIG. 2 illustrates an example orientation of induction heating workcoils with respect to a roll, various changes may be made to FIG. 2. For example, any suitable number of induction heating workcoils could be used with the roll 212. Although FIGS. 3A through 4C illustrate examples of induction heating workcoils, various changes may be made to FIGS. 3A through 4C. For instance, cores with any other suitable shape(s) and with coil(s) in any suitable location(s) on the core(s) could be used. In general, any induction heating workcoil that can be oriented at an angle with respect to a roll's direction of rotation to reduce or minimize crosstalk could be used here.

FIG. 5 illustrates example reductions in crosstalk due to rotation of induction heating workcoils according to this disclosure. The reductions shown in FIG. 5 are for illustration only. Induction heating workcoils having other behaviors when rotated could also be used.

As shown in FIG. 5, a chart 500 plots an angle of rotation against inductive coupling (crosstalk). Lines 502-512 define the amount of crosstalk between neighboring parallel induction heating workcoils at different power levels and separations. For example, line 502 represents the amount of crosstalk between neighboring parallel induction heating workcoils energized using a 4 kW signal, where the workcoils have a 100 mm separation. Line 504 represents the amount of crosstalk between neighboring parallel induction heating workcoils energized using a 6 kW signal, where the workcoils have a 100 mm separation. Line 506 represents the amount of crosstalk between neighboring parallel induction heating workcoils energized using a 4 kW signal, where the workcoils have a 120 mm separation. Line 508 represents the amount of crosstalk between neighboring parallel induction heating workcoils energized using a 6 kW signal, where the workcoils have a 120 mm separation. Line 510 represents the amount of crosstalk between neighboring parallel induction heating workcoils energized using a 4 kW signal, where the workcoils have a 150 mm separation. Line 512 represents the amount of crosstalk between neighboring parallel induction heating workcoils energized using a 6 kW signal, where the workcoils have a 150 mm separation.

As shown here, the prior technique of rotating balanced workcoils (with cores dependent on roll diameter) by 11° to 13° in order to average the energy transfer profile would not result in a significant reduction in crosstalk. In FIG. 5, this amount of rotation would result in less than a 10% reduction in crosstalk. In contrast, as shown in FIG. 5, rotating the induction heating workcoils by a larger amount causes a significant reduction in the amount of crosstalk between workcoils. For example, a rotation of 25° reduces crosstalk in all of these examples by at least 50%. A rotation of 35° reduces crosstalk in all of these examples by at least 80-90%.

Note that rotating the induction heating workcoils may have a negative impact on the thermal profile across a roll. For example, rotating the induction heating workcoils may result in thermal profile degradation (defined as a divergence of the thermal profile from a Gaussian statistical distribution). Also, increasing the workcoils' angle of rotation past a certain point may result in shoulders within the thermal profile, which can inhibit controllability. As a result, a balance can be struck between acceptable levels of crosstalk and acceptable levels of thermal profile degradation. In the examples shown in FIG. 5, the 35° rotation may provide a sufficient reduction in crosstalk, while the thermal profile shape may have an acceptable degradation. Therefore, using obliquely-arranged workcoils to a curved surface can reduce crosstalk to low levels (enabling close proximity of banks of workcoils) without compromising the thermal profile to a significant degree.

Although FIG. 5 illustrates example reductions in crosstalk due to rotation of induction heating workcoils, various changes may be made to FIG. 5. For example, the results in FIG. 5 are associated with a particular implementation of induction heating workcoils (the ones shown in FIGS. 3A and 3B) Other induction heating workcoils may have different results based on their geometries, sizes, and positions. As such, an appropriate angle of rotation (or range of angles) can be easily determined and selected based on the actual workcoils to be used, the desired reduction in crosstalk, and the acceptable level of thermal profile degradation.

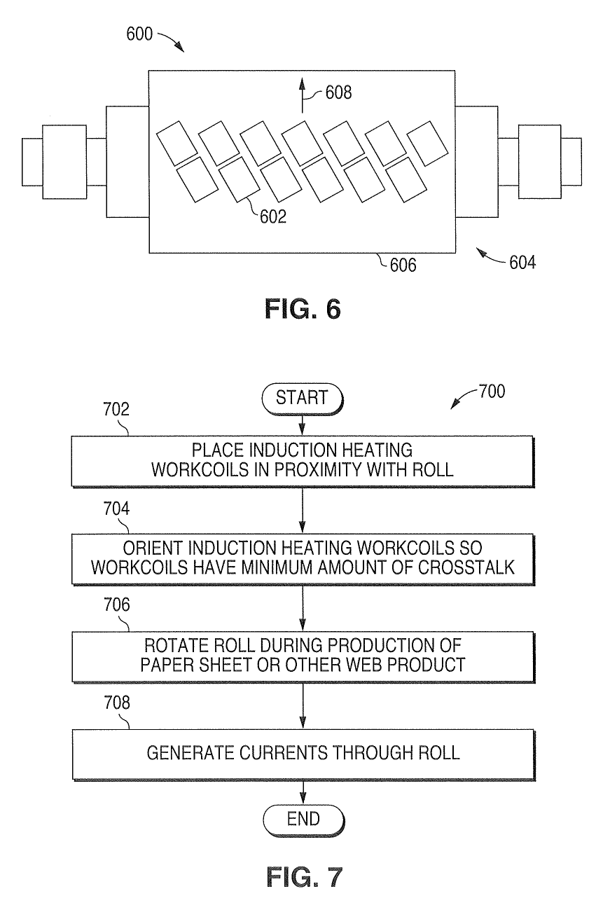

FIG. 6 illustrates an example configuration 600 of induction heating workcoils with respect to a roll according to this disclosure. As shown in FIG. 6, the configuration 600 includes multiple induction heating workcoils 602 placed adjacent to each other in an end-to-end fashion across the surface of a roll 604. The induction heating workcoils 602 could have any suitable spacing, such as one induction heating workcoil every 50 mm-150 mm. The configuration 600 also includes multiple rows of induction heating workcoils 602. The induction heating workcoils 602 in the different rows may or may not be offset, and the rows could have any suitable spacing. Also, various induction heating workcoils 602 could form part of a larger unit, such as when the workcoils 602 in one or more rows reside within a single package.

The induction heating workcoils 602 operate to produce currents in different areas or zones of a conductive shell 606 of the roll 604. The conductive shell 606 generally represents the portion of the roll 604 that contacts a paper sheet or other product being formed. The conductive shell 606 or the roll 604 could be formed from any suitable material(s), such as a metallic ferromagnetic material. The currents could also be produced in different areas or zones of the roll 604 itself, such as when the roll 604 is solid. The amount of current flowing through the zones could be controlled by adjusting the amount of energy flowing into the coils of the induction heating workcoils 602 (via control of the power sources 210). This control could, for example, be provided by the controller 104 in the paper production system 100 of FIG. 1.

In order to reduce or minimize crosstalk between the workcoils 602, the workcoils 602 (or at least the magnetic flux vectors they produce) are angled with respect to the roll's direction of rotation 608. As noted above, a rotation angle of 35°, for example, may significantly reduce crosstalk while allowing acceptable control over a roll's thermal profile. However, other angles of rotation could also be used.

Although FIG. 6 illustrates one example of a configuration 600 of induction heating workcoils with respect to a roll, various changes may be made to FIG. 6. For example, the configuration 600 could include any number of rows of induction heating workcoils 602 at any uniform or non-uniform spacing. Also, each row could include any number of induction heating workcoils 602 at any uniform or non-uniform spacing.

FIG. 7 illustrates an example method for reducing crosstalk between workcoils in induction heating applications according to this disclosure. As shown in FIG. 7, one or more induction heating workcoils are placed in proximity to a roll at step 702. This could include, for example, placing one or multiple induction heating workcoils 120 near a roll 119 in a paper calender. Any suitable number of induction heating workcoils could be placed near the roll, and the induction heating workcoils could have any suitable arrangement or configuration.

The induction heating workcoils are oriented at step 704. This could include, for example, orienting the induction heating workcoils so that the magnetic flux vectors 220 they produce are rotated at an angle with respect to the roll's direction of rotation. This results in magnetic flux vectors 220 that are not parallel to the roll's direction of rotation 216. Any suitable angle can be used here, as long as crosstalk between the workcoils is reduced significantly and adequate control over the thermal profile remains.

Once installed and oriented, the roll can be rotated during the production of a paper sheet or other continuous web product at step 706, and currents are produced through the roll at step 708. The currents can be generated by providing AC signals to the coils 204 of the induction heating workcoils. Moreover, a reduced or minimized amount of crosstalk may occur between the induction heating workcoils as a result of their orientation. This may help to reduce or prevent energy transfer between workcoils, which allows for more effective control over the production process.

Although FIG. 7 illustrates an example method for reducing crosstalk between workcoils in induction heating applications, various changes may be made to FIG. 7. For example, while shown as a series of steps, various steps shown in FIG. 7 could overlap, occur in parallel, occur in a different order, or occur multiple times.

It may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a roll comprising a conductive material, the roll configured to rotate about an axis and having a direction of rotation; and
multiple unbalanced induction heating workcoils each configured to induce one or more magnetic fluxes within the roll to generate one or more electrical currents within the roll;
wherein each of the unbalanced induction heating workcoils is oriented so that a mean magnetic flux induced by the workcoil is oblique to the roll's direction of rotation.

2. The system of claim 1, wherein each of the induction heating workcoils is oriented so that its mean magnetic flux forms an angle of at least 25° and less than 90° with respect to the roll's direction of rotation.

3. The system of claim 2, wherein inductive coupling between the induction heating workcoils is at least 50% less compared to inductive coupling between the induction heating workcoils when the induction heating workcoils are oriented so that their mean magnetic fluxes are parallel to the roll's direction of rotation.

4. The system of claim 1, wherein each of the induction heating workcoils is oriented so that its mean magnetic flux forms an angle of approximately 35° with respect to the roll's direction of rotation.

5. The system of claim 1, wherein each induction heating workcoil comprises at least one core and at least one coil wound around the at least one core.

6. The system of claim 5, wherein each induction heating workcoil comprises a C-shaped or U-shaped core having two outer legs and multiple coils each wound around one of the outer legs.

7. The system of claim 1, wherein the roll comprises one of a set of counter-rotating rolls, the counter-rotating rolls configured to compress a web of material.

8. The system of claim 7, wherein:
each of multiple induction heating actuators comprises at least one of the induction heating workcoils and at least one power source; and
the system further comprises a controller configured to control the power sources of the induction heating actuators to control an amount of compression provided by at least a portion of the counter-rotating rolls.

9. A system comprising:
a roll comprising a conductive material, the roll configured to rotate about an axis and having a diameter and a direction of rotation; and
multiple induction heating workcoils each configured to induce one or more magnetic fluxes within the roll to generate one or more electrical currents within the roll;
wherein each of the induction heating workcoils is oriented so that a mean magnetic flux induced by the workcoil is oblique to the roll's direction of rotation; and
wherein each of the induction heating workcoils comprises a core having a shape that is not substantially dependent on the roll's diameter.

10. The system of claim 9, wherein each of the induction heating workcoils is oriented so that its mean magnetic flux forms an angle of at least 25° and less than 90° with respect to the roll's direction of rotation.

11. The system of claim 10, wherein inductive coupling between the induction heating workcoils is at least 50% less compared to inductive coupling between the induction heating workcoils when the induction heating workcoils are oriented so that their mean magnetic fluxes are parallel to the roll's direction of rotation.

12. The system of claim 9, wherein each of the induction heating workcoils is oriented so that its mean magnetic flux forms an angle of approximately 35° with respect to the roll's direction of rotation.

13. The system of claim 9, wherein each induction heating workcoil comprises an unbalanced induction heating workcoil.

14. The system of claim 13, wherein each induction heating workcoil comprises a C-shaped or U-shaped core having two outer legs and multiple coils each wound around one of the outer legs.

15. The system of claim 9, wherein the roll comprises one of a set of counter-rotating rolls, the counter-rotating rolls configured to compress a web of material.

16. The system of claim 15, wherein:
each of multiple induction heating actuators comprises at least one of the induction heating workcoils and at least one power source; and
the system further comprises a controller configured to control the power sources of the induction heating actuators to control an amount of compression provided by at least a portion of the counter-rotating rolls.

17. A method comprising:
placing multiple induction heating workcoils in proximity with a roll; and
generating multiple electrical currents within the roll using the induction heating workcoils;
wherein each induction heating workcoil is oriented such that a mean of one or more magnetic fluxes induced within the roll by the workcoil is oblique to the roll's direction of rotation so as to reduce inductive coupling between the induction heating workcoils.

18. The method of claim 17, wherein inductive coupling between the induction heating workcoils is at least 50% less compared to inductive coupling between the induction heating workcoils when the induction heating workcoils are oriented so that their mean magnetic fluxes are parallel to the roll's direction of rotation.

19. The method of claim 17, wherein inductive coupling between the induction heating workcoils is at least 75% less compared to inductive coupling between the induction heating workcoils when the induction heating workcoils are oriented so that their mean magnetic fluxes are parallel to the roll's direction of rotation.

20. The method of claim 17, wherein the induction heating workcoils comprise unbalanced induction heating workcoils.
